(19) United States
(12) Patent Application Publication
(10) Pub. No.: US 2022/0252418 A1
(43) Pub. Date: Aug. 11, 2022

(54) DISPLAY TERMINAL, DISPLAY SYSTEM, DISPLAY METHOD, AND COMPUTER-READABLE MEDIUM

(71) Applicant: Panasonic Intellectual Property Management Co., Ltd., Osaka (JP)

(72) Inventor: Akihiko IGUCHI, Osaka Fu (JP)

(73) Assignee: Panasonic Intellectual Property Management Co., Ltd., Osaka (JP)

(21) Appl. No.: 17/734,641

(22) Filed: May 2, 2022

Related U.S. Application Data
(63) Continuation of application No. PCT/JP2020/030493, filed on Aug. 7, 2020.

(30) Foreign Application Priority Data
Nov. 18, 2019 (JP) 2019-207617

(51) Int. Cl. G01C 21/34; G07C 5/00

(52) U.S. Cl. CPC G01C 21/3469; G07C 5/008

(57) ABSTRACT

A display terminal according to the present disclosure include a memory, and a hardware processor coupled to the memory. The hardware processor is configured to: acquire route information indicating a first traveling route and a second traveling route; and configured to display the first traveling route and the second traveling route. The first traveling route is a route related to an own vehicle among a plurality of traveling routes for suppressing battery deterioration related to a plurality of vehicles calculated based on destination information related to a plurality of destinations and accumulated battery data. The second traveling route is a route related to a second vehicle in a traveling area adjacent to a traveling area of the own vehicle among the plurality of traveling routes.

### CROSS-REFERENCE TO RELATED APPLICATIONS

This application is a continuation of International Application No. PCT/JP2020/030493, filed on Aug. 7, 2020 which claims the benefit of priority of the prior Japanese Patent Application No. 2019-207616, filed on Nov. 18, 2019, the entire contents of which are incorporated herein by reference.

### FIELD

Embodiments described herein relate generally to a display terminal, a display system, a display method, and a computer-readable medium.

### BACKGROUND

Conventionally, various types of vehicles, such as an electric vehicle and a hybrid vehicle, using a battery have been used for various types of delivery operations such as a delivery service, for example. There has been known a technique of suggesting a recommended traveling route to a user of a vehicle such as a delivery driver, for example, in view of energy cost and a deterioration amount of a battery. Conventional technologies are described in Japanese Patent Application Laid-open No. 2009-063555, for example.

The present disclosure provides a display terminal, a display system, a display method, and a computer-readable medium that can prompt a user to use a recommended traveling route.

### SUMMARY

A display terminal according to the present disclosure include a memory, and a hardware processor coupled to the memory. The hardware processor is configured to: acquire route information indicating a first traveling route and a second traveling route; and configured to display the first traveling route and the second traveling route. The first traveling route is a route related to an own vehicle among a plurality of traveling routes for suppressing battery deterioration related to a plurality of vehicles calculated based on destination information related to a plurality of destinations and accumulated battery data. The second traveling route is a route related to a second vehicle in a traveling area adjacent to a traveling area of the own vehicle among the plurality of traveling routes.

### BRIEF DESCRIPTION OF THE DRAWINGS

FIG. 1 is a diagram illustrating an example of a configuration of a delivery route display system according to a first embodiment;

FIG. 2 is a diagram illustrating an example of a hardware configuration of a delivery route display terminal according to the first embodiment;

FIG. 3 is a diagram illustrating an example of functions of the delivery route display terminal according to the first embodiment;

FIG. 4 is a diagram illustrating an example of a hardware configuration of a delivery route calculation system according to the first embodiment;

FIG. 5 is a diagram illustrating an example of functions of the delivery route calculation system according to the first embodiment;

FIG. 6 is a flowchart illustrating an example of delivery route calculation processing performed by the delivery route calculation system according to the first embodiment;

FIG. 7 is a flowchart illustrating an example of delivery route display processing performed by the delivery route display terminal according to the first embodiment;

FIG. 8 is a diagram illustrating an example of a display screen displayed in the delivery route display processing according to the first embodiment;

FIG. 9 is a diagram illustrating an example of a display screen displayed in delivery route display processing according to a first modification;

FIG. 10 is a diagram illustrating an example of functions of a delivery route calculation system according to a second modification;

FIG. 11 is a diagram illustrating an example of functions of a delivery route calculation system according to a third modification;

FIG. 12 is a diagram illustrating an example of functions of a delivery route calculation system according to a fourth modification;

FIG. 13 is a flowchart illustrating an example of evaluation index calculation processing performed by the delivery route calculation system according to the fourth modification;

FIG. 14 is a diagram illustrating an example of a display screen displayed in delivery route display processing according to the fourth modification;

FIG. 15 is a diagram illustrating an example of functions of a delivery route calculation system according to a fifth modification;

FIG. 16 is a flowchart illustrating an example of evaluation index calculation processing performed by the delivery route calculation system according to the fifth modification;

FIG. 17 is a diagram illustrating an example of a display screen displayed in delivery route display processing according to the fifth modification;

FIG. 18 is a diagram illustrating an example of a display screen displayed in delivery route display processing according to a sixth modification;

FIG. 19 is a diagram illustrating an example of functions of a delivery route calculation system according to a seventh modification;

FIG. 20 is a flowchart illustrating an example of evaluation index calculation processing performed by the delivery route calculation system according to the seventh modification;

FIG. 21 is a diagram illustrating an example of a display screen displayed in delivery route display processing according to a seventh modification;

FIG. 22 is a diagram illustrating an example of functions of a delivery route calculation system according to a second embodiment;

FIG. 23 is a flowchart illustrating an example of delivery route calculation processing performed by the delivery route calculation system according to the second embodiment;

FIG. 24 is a diagram illustrating an example of a display screen displayed in delivery route display processing according to the second embodiment;

FIG. 25 is a diagram illustrating another example of a display screen displayed in the delivery route display processing according to the second embodiment;

FIG. 26 is a diagram illustrating an example of functions of a delivery route calculation system according to an eighth modification;

FIG. 27 is a flowchart illustrating an example of evaluation index calculation processing performed by the delivery route calculation system according to the eighth modification;

FIG. 28 is a diagram illustrating an example of a display screen displayed in delivery route display processing according to the eighth modification;

FIG. 29 is a diagram illustrating an example of functions of a delivery route calculation system according to a ninth modification;

FIG. 30 is a flowchart illustrating an example of delivery route calculation processing performed by the delivery route calculation system according to the ninth modification; and

FIG. 31 is a diagram illustrating an example of a display screen displayed in delivery route display processing according to the ninth modification.

### DETAILED DESCRIPTION

The following describes embodiments of a display terminal, a display system, and a display method according to the present disclosure with reference to the drawings.

The following exemplifies a case in which the technique according to the present disclosure is applied to various delivery operations such as a delivery service, for example. The technique according to the present disclosure is not limited to a cargo but can also be applied to a case where a person is transported, such as ride sharing, a shared taxi, and a passenger bus, for example. The technique according to the present disclosure can also be applied to a case in which a plurality of drivers use the same vehicle such as a rent-a-car, for example.

The following exemplifies a case where the technique according to the present disclosure is applied to various types of vehicles, such as an electric vehicle and a hybrid vehicle, using a battery, for example. The various types of vehicles that use a battery include, for example, a bicycle, a motorcycle, an automobile, and an electric train. The technique according to the present disclosure can be applied not only to vehicles but also to various types of mobile objects that use a battery such as a ship and an aircraft.

### First Embodiment

Conventionally, various vehicles, such as an electric vehicle and a hybrid vehicle, using a battery have been used for various delivery operations such as a delivery service, for example. Additionally, there has been known a technique of suggesting a recommended delivery route to a user of a vehicle such as a delivery driver, for example, in view of energy cost and a deterioration amount of the battery, for example.

In such a situation, there has been a demand that the user uses the recommended delivery route for suppressing deterioration of the battery, for example. However, if the recommended delivery route is simply suggested, the user may feel that a delivery route assumed by the user himself/herself is more appropriate than the suggested delivery route. Thus, the user is unconvinced of using the suggested delivery route in place of the delivery route assumed by himself/herself in some cases. In the case in which the user does not select the recommended delivery route because the user is unconvinced or other reasons, deterioration of the battery cannot be suppressed.

A technique according to a first embodiment provides a display terminal, a display system, and a display method that can prompt the user to use the recommended delivery route in place of the assumed delivery route.

Specifically, the display system according to the first embodiment is a system that presents, to the user, a deterioration suppressing route that is recommended to be used and reference data as a standard for evaluating the deterioration suppressing route. The reference data includes an assumed route that is a delivery route as a comparison target, and evaluation indexes. It can be expressed that the reference data is information for prompting the user to use the deterioration suppressing route, that is, the recommended delivery route.

More specifically, the display system according to the first embodiment is a system that estimates the assumed route, calculates the deterioration suppressing route, calculates the evaluation indexes with which these two delivery routes can be quantitatively evaluated, and displays the evaluation indexes together with the assumed route and the deterioration suppressing route. The assumed route and the deterioration suppressing route may be referred to as two delivery routes in some cases. In the display system, the display terminal displays the two delivery routes together with the evaluation indexes.

Herein, estimating the assumed route means executing calculation for estimating the assumed route. The assumed route is a delivery route assumed by a driver, and is an example of a first traveling route. The deterioration suppressing route is a delivery route for suppressing battery deterioration that is recommended to be used, and is an example of a second traveling route.

The evaluation indexes according to the first embodiment are assumed to be battery deterioration amounts when using the respective delivery routes.

The following describes the display terminal, the display system, and the display method according to the first embodiment in more detail.

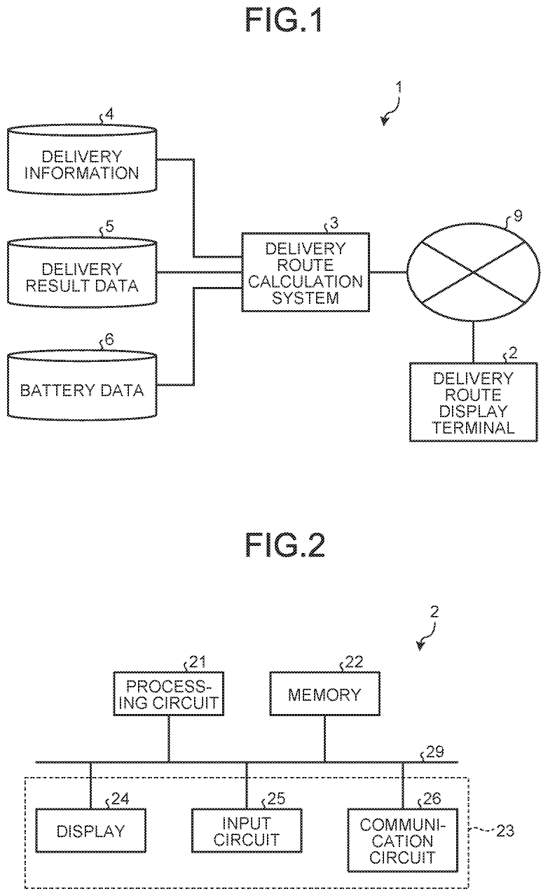

FIG. 1 is a diagram illustrating an example of a configuration of a delivery route display system 1 according to the first embodiment. As illustrated in FIG. 1, the delivery route display system 1 includes a delivery route display terminal 2 and a delivery route calculation system 3. The delivery route display terminal 2 and the delivery route calculation system 3 are connected to each other in a communicable manner via a network 9. As the network 9, an electric communication line such as the Internet can be used, for example.

The delivery route display terminal 2 is a terminal that displays the assumed route and the deterioration suppressing route together with a battery deterioration amount corresponding to the assumed route and a battery deterioration amount corresponding to the deterioration suppressing route. The respective battery deterioration amounts corresponding to the assumed route and the deterioration suppressing route may be referred to as two battery deterioration amounts in some cases. As the delivery route display terminal 2, a smartphone, a tablet PC, a car navigation system, and the like can be appropriately used. FIG. 2 is a diagram illustrating an example of a hardware configuration of the delivery route display terminal 2 according to the first embodiment. As illustrated in FIG. 2, the delivery route display terminal 2 includes a processing circuit 21, a memory 22, and an I/F unit 23. The processing circuit 21, the memory 22, and the I/F unit 23 are connected to each other in a communicable manner via a bus 29, for example.

The processing circuit 21 controls the entire operation of the delivery route display terminal 2. As the processing circuit 21, a central processing unit (CPU) can be used, for example, but another processor such as a graphics processing unit (GPU), an application specific integrated circuit (ASIC), or a field programmable gate array (FPGA) may also be used.

The memory 22 stores various kinds of data or computer programs used in the delivery route display terminal 2. The data stored in the memory 22 includes data received from the delivery route calculation system 3. The computer programs stored in the memory 22 include a delivery route display program on the terminal side (described later). As the memory 22, various storage media such as an HDD or a Flash memory can be used. In the memory 22, a random access memory (RAM) for temporarily storing data being operated is further disposed.

The I/F unit 23 includes a display 24, an input circuit 25, and a communication circuit 26. As the display 24, a liquid crystal display, an organic EL display, a projector, and the like can be appropriately used, for example. The input circuit 25 is a circuit that receives an input from the user, and a touch panel or a keyboard can be used as the input circuit 25, for example. The communication circuit 26 is a circuit for communicating with the outside of the delivery route display terminal 2. As the communication circuit 26, a communication circuit for wired communication, a communication circuit for wireless communication, and a combination thereof can be appropriately used. As the communication circuit for wireless communication, a communication circuit corresponding to any of various standards such as 3G, 4G, Wi-Fi (registered trademark), and Bluetooth (registered trademark) can be appropriately used.

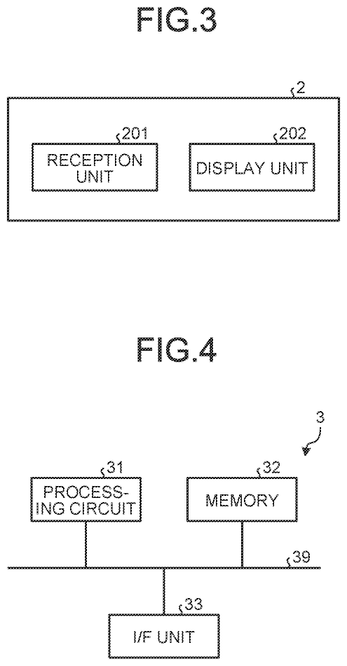

FIG. 3 is a diagram illustrating an example of functions of the delivery route display terminal 2 according to the first embodiment. The delivery route display terminal 2 implements functions as a reception unit 201 and a display unit 202 when the processing circuit 21 executes the delivery route display program on the terminal side loaded into the memory 22, for example.

The reception unit 201 acquires route information indicating the two delivery routes and the corresponding two battery deterioration amounts received from the delivery route calculation system 3. The reception unit 201 is an example of an acquisition unit. The display unit 202 displays the two delivery routes and the corresponding two battery deterioration amounts acquired by the reception unit 201.

The delivery route calculation system 3 is a server that executes calculation for estimating the assumed route, calculates the deterioration suppressing route, and calculates the battery deterioration amount corresponding to each of the two delivery routes. FIG. 4 is a diagram illustrating an example of a hardware configuration of the delivery route calculation system 3 according to the first embodiment. As illustrated in FIG. 4, the delivery route calculation system 3 includes a processing circuit 31, a memory 32, and an I/F unit 33. The processing circuit 31, the memory 32, and the I/F unit 33 are connected to each other in a communicable manner via a bus 39, for example.

The processing circuit 31 controls the entire operation of the delivery route calculation system 3. As the processing circuit 31, a CPU can be used, for example, but another processor such as a GPU, an ASIC, or an FPGA may also be used.

The memory 32 stores various kinds of data or computer programs used in the delivery route calculation system 3. The computer programs stored in the memory 32 include a delivery route display program on a server side (described later). As the memory 32, various storage media such as an HDD or a Flash memory can be used. In the memory 32, a RAM for temporarily storing data being operated is further provided.

The I/F unit 33 includes an input circuit and a communication circuit. The input circuit is a circuit that receives an input from the user, and a touch panel or a keyboard can be used as the input circuit, for example. The communication circuit is a circuit for communicating with the outside of the delivery route calculation system 3. The I/F unit 33 may further include a display circuit that is connected to a display device such as a display and outputs data for display.

The delivery route calculation system 3 is configured to be able to access databases respectively storing delivery information 4, delivery result data 5, and battery data 6. As each of the databases respectively storing the delivery information 4, the delivery result data 5, and the battery data 6, a computer incorporating a storage device can be appropriately used, for example.

The database storing the delivery information 4 is assumed to be stored in a computer, a data server, and the like managed by a company and the like to which a delivery driver belongs, for example. The delivery information 4 is information set for each driver or each vehicle, and information indicating a delivery address and a delivery time related to each of a plurality of cargos. The delivery information 4 is an example of destination information related to a plurality of destinations. The delivery address is an example of a destination. The delivery time is an example of an arrival time to the destination.

The databases respectively storing the delivery result data 5 and the battery data 6 are assumed to be stored in a computer, a data server, and the like managed by a company and the like to which a delivery driver belongs, for example. The delivery result data 5 is history data indicating delivery information classified for each driver, a used delivery route, and characteristics of a used delivery vehicle, for example. The used delivery route is assumed to be a delivery route that has been actually used. The characteristics of the delivery vehicle include a weight of the vehicle, classification of the vehicle such as an electric vehicle or a hybrid vehicle, a type of a mounted battery, capacity of the battery, presence/absence of a regeneration brake, and the like. The battery data 6 is information indicating characteristics of the battery mounted on the delivery vehicle. The characteristics of the battery include the capacity, a maximum output, a rating output, output variation corresponding to a load, and the like of the battery, for example.

The databases respectively storing the delivery result data 5 and the battery data 6 may be stored in various storage media such as an HDD or a Flash memory mounted on the delivery vehicle.

As the delivery result data 5, route information indicating the assumed route and the deterioration suppressing route may be further stored. In this case, only a value indicating which of the delivery routes is used may be stored instead of the route information about the respective delivery routes.

The delivery information 4, the delivery result data 5, and the battery data 6 may be supplied from each of the databases to the delivery route calculation system 3 via the network 9, or may be supplied from each of the databases to the delivery route calculation system 3 via a computer-readable recording medium or a transportable external storage device. As the computer-readable recording medium, for example, a CD-ROM, a flexible disk (FD), a CD-R, a digital versatile disc (DVD), and the like can be appropriately used. As the transportable external storage device, an HDD, a Flash memory, and the like can be appropriately used.

The databases respectively storing the delivery information 4, the delivery result data 5, and the battery data 6 may be stored in one server and the like, or may be stored in a plurality of servers and the like in a distributed manner. The databases respectively storing the delivery information 4, the delivery result data 5, and the battery data 6 may be stored in the delivery route display terminal 2 or the delivery route calculation system 3.

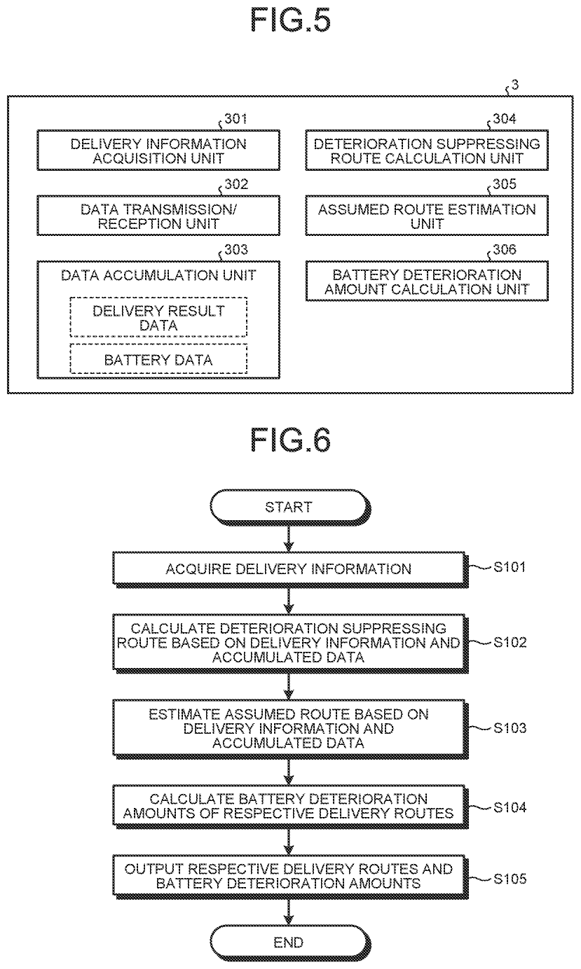

FIG. 5 is a diagram illustrating an example of functions of the delivery route calculation system 3 according to the first embodiment. The delivery route calculation system 3 implements functions as a delivery information acquisition unit 301, a data transmission/reception unit 302, a data accumulation unit 303, a deterioration suppressing route calculation unit 304, an assumed route estimation unit 305, and a battery deterioration amount calculation unit 306 when the processing circuit 31 executes the delivery route display program on the server side loaded into the memory 32, for example.

The delivery information acquisition unit 301 acquires the delivery information 4 from the database. The data transmission/reception unit 302 receives the delivery result data 5 and the battery data 6 from each of the databases. The data transmission/reception unit 302 also transmits the route information indicating the two delivery routes, and the battery deterioration amounts of the respective delivery routes to the delivery route display terminal 2. The data accumulation unit 303 accumulates the delivery result data 5 and the battery data 6 received from the respective databases by the data transmission/reception unit 302. The deterioration suppressing route calculation unit 304 calculates the deterioration suppressing route based on the delivery information 4 acquired by the delivery information acquisition unit 301 and the battery data 6 accumulated by the data accumulation unit 303. The assumed route estimation unit 305 executes calculation for estimating the assumed route based on the delivery information 4 acquired by the delivery information acquisition unit 301 and the delivery result data 5 accumulated by the data accumulation unit 303. The battery deterioration amount calculation unit 306 calculates the battery deterioration amount in a case in which each of the delivery routes is used.

The functions as the delivery information acquisition unit 301, the data transmission/reception unit 302, the data accumulation unit 303, the deterioration suppressing route calculation unit 304, the assumed route estimation unit 305, and the battery deterioration amount calculation unit 306 may also be implemented by distributed processing performed by two or more servers. At least one of the functions as the delivery information acquisition unit 301, the data transmission/reception unit 302, the data accumulation unit 303, the deterioration suppressing route calculation unit 304, the assumed route estimation unit 305, and the battery deterioration amount calculation unit 306 may also be implemented by the delivery route display terminal 2. For example, the delivery route display terminal 2 and the delivery route calculation system 3 may be integrally configured.

The following describes operation of the delivery route display system 1 according to the first embodiment with reference to the drawings. The delivery route display system 1 performs server client processing that is implemented by delivery route calculation processing as server processing performed by the delivery route calculation system 3 and delivery route display processing as client processing performed by the delivery route display terminal 2.

FIG. 6 is a flowchart illustrating an example of the delivery route calculation processing performed by the delivery route calculation system 3 according to the first embodiment.

First, the delivery information acquisition unit 301 acquires the delivery information 4 from the database (S101). Subsequently, the deterioration suppressing route calculation unit 304 calculates the deterioration suppressing route based on the delivery information 4 and the battery data 6 (S102). The battery data 6 is assumed to be received from the database by the data transmission/reception unit 302 and accumulated by the data accumulation unit 303 before the processing at S102. The assumed route estimation unit 305 calculates the assumed route based on the delivery information 4 and the delivery result data 5 (S103). The delivery result data 5 is assumed to be received from the database by the data transmission/reception unit 302 and accumulated by the data accumulation unit 303 before the processing at S103.

The deterioration suppressing route calculation unit 304 may supply the delivery information 4 and the battery data 6 to the battery deterioration amount calculation unit 306, and calculate the deterioration suppressing route based on an output from the battery deterioration amount calculation unit 306 corresponding to the delivery information 4 and the battery data 6. The deterioration suppressing route calculation unit 304 and the battery deterioration amount calculation unit 306 may be configured as one function.

The battery deterioration amount calculation unit 306 calculates the battery deterioration amount of each of the delivery routes (S104). Specifically, the battery deterioration amount calculation unit 306 acquires the delivery route from each of the deterioration suppressing route calculation unit 304 and the assumed route estimation unit 305. The battery deterioration amount calculation unit 306 calculates the battery deterioration amount when using each of the delivery routes based on intervals between delivery addresses and intervals between signals in each of the acquired delivery routes, a congestion state, a type of the battery mounted on the vehicle, and the like. The processing at S104 is an example of evaluation index calculation processing for calculating the evaluation index related to the two delivery routes. The data transmission/reception unit 302 outputs the route information indicating the two delivery routes and the battery deterioration amount of each of the delivery routes (S105). The output route information and battery deterioration amount are supplied to the delivery route display terminal 2.

The processing at S103 may be performed before the processing at S102. The processing at S104 may be performed after the processing at S102 and the processing at S103.

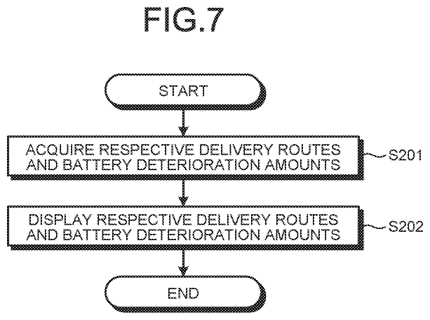

FIG. 7 is a flowchart illustrating an example of the delivery route display processing performed by the delivery route display terminal 2 according to the first embodiment.

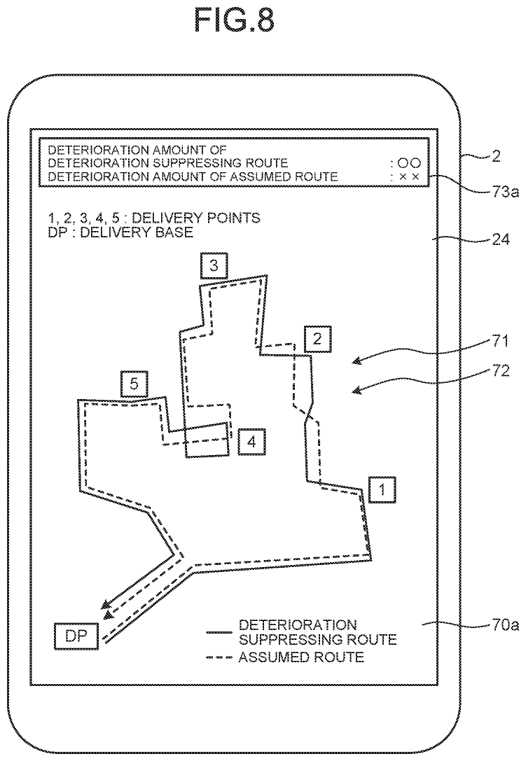

The reception unit 201 acquires the route information indicating the two delivery routes and the corresponding two battery deterioration amounts received from the delivery route calculation system 3 (S201). Subsequently, the display unit 202 generates image data for displaying the two delivery routes and the corresponding two battery deterioration amounts acquired by the reception unit 201, and displays a display screen based on the generated image data (S202). FIG. 8 is a diagram illustrating an example of the display screen displayed in the processing at S202. A display screen 70a in FIG. 8 includes a deterioration suppressing route 71 as a recommended delivery route, and reference data. The reference data includes an assumed route 72 and evaluation indexes 73a. The evaluation indexes 73a include the battery deterioration amounts of the respective delivery routes. The display screen 70a further includes a delivery base DP and a plurality of delivery points.

The display unit 202 may display that, when the two battery deterioration amounts corresponding to the deterioration suppressing route 71 and the assumed route 72 are the same value, any of the delivery route among the deterioration suppressing route 71 and the assumed route 72 may be selected. Herein, the case in which the two battery deterioration amounts are the same value includes a case in which a difference between the two battery deterioration amounts falls within a predetermined range. The predetermined range is assumed to be set in advance, and stored in the memory 22 and the like, for example.

The delivery route calculation system 3 may perform the delivery route calculation processing by being triggered by a request from the delivery route display terminal 2, for example, or may perform the delivery route calculation processing by being triggered by registration of the delivery information 4 to the database. The delivery route calculation system 3 may also output the route information and the battery deterioration amount by being triggered by a request from the delivery route display terminal 2, for example.

In the processing at S105, image data for displaying a display screen 710 may be generated. In this case, the delivery route display terminal 2 acquires the image data from the delivery route calculation system 3, and displays the display screen 710 based on the acquired image data.

Part of or the entire delivery route calculation processing may be performed by the delivery route display terminal 2. For example, the delivery route display terminal 2 may acquire the route information from the delivery route calculation system 3, and calculate the battery deterioration amount of each of the delivery routes (S104). Additionally, for example, the delivery route display terminal 2 may accumulate the delivery result data 5, acquire the delivery information 4 from the delivery route calculation system 3 or the database (S101), and execute calculation for estimating the assumed route (S103). Similarly, the delivery route display terminal 2 may calculate the deterioration suppressing route by acquiring or accumulating required information from the delivery route calculation system 3 or the database (S101, S102).

In this way, the delivery route display system 1 according to the first embodiment displays the reference data together with the deterioration suppressing route that is recommended to be used. Specifically, the deterioration suppressing route is a delivery route for suppressing battery deterioration that is calculated based on the delivery information 4 related to a plurality of delivery addresses and the accumulated battery data 6. The reference data includes the assumed route and the evaluation indexes. The assumed route is a delivery route assumed by the driver that is estimated based on the delivery information 4 related to the delivery addresses and the accumulated delivery result data 5. The evaluation indexes are indexes with which the deterioration suppressing route and the assumed route can be quantitatively evaluated, for example, the battery deterioration amounts of the respective delivery routes.

With this configuration, the user can determine whether the deterioration suppressing route is appropriate based on the reference data. In other words, the user can quantitatively compare the two delivery routes including the assumed route and the deterioration suppressing route with each other based on the battery deterioration amounts of the respective displayed delivery routes. Due to this, the user can be convinced of using the deterioration suppressing route in place of the assumed route. The convinced user can select the deterioration suppressing route without a feeling of resistance. That is, the delivery route display system 1 according to the first embodiment can prompt the user to use the deterioration suppressing route.

The following describes modifications of the first embodiment. The following mainly describes differences from the first embodiment, and redundant description will be appropriately omitted.

First Modification

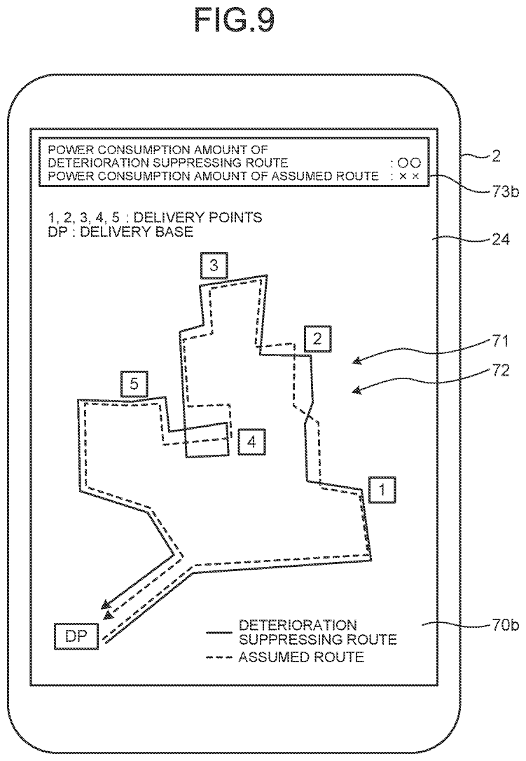

The first embodiment exemplifies the battery deterioration amounts when using the respective delivery routes as the evaluation indexes, but the embodiment is not limited thereto. As the evaluation indexes, power consumption amounts when using the respective delivery routes may be used. The power consumption amounts respectively corresponding to the assumed route and the deterioration suppressing route may be collectively referred to as two power consumption amounts in some cases. The battery deterioration amount calculation unit 306 according to a first modification calculates the power consumption amounts of the respective delivery routes (S104). The display unit 202 displays the two delivery routes together with the power consumption amounts of the respective delivery routes (S202). FIG. 9 is a diagram illustrating another example of the display screen displayed in the processing at S202 in FIG. 7. A display screen 70b in FIG. 9 includes the deterioration suppressing route 71 as the recommended delivery route, and the reference data. The reference data includes the assumed route 72 and evaluation indexes 73b. The evaluation indexes 73b include the power consumption amounts of the respective delivery routes. The display screen 70b further includes the delivery base DP and a plurality of delivery points. In this way, the delivery route display system 1 according to the first modification displays the power consumption amounts in place of the battery deterioration amounts. The delivery route display system 1 may also be configured to display the power consumption amounts in addition to the battery deterioration amounts. With this configuration, the same effect as that of the first embodiment can be obtained.

Second Modification

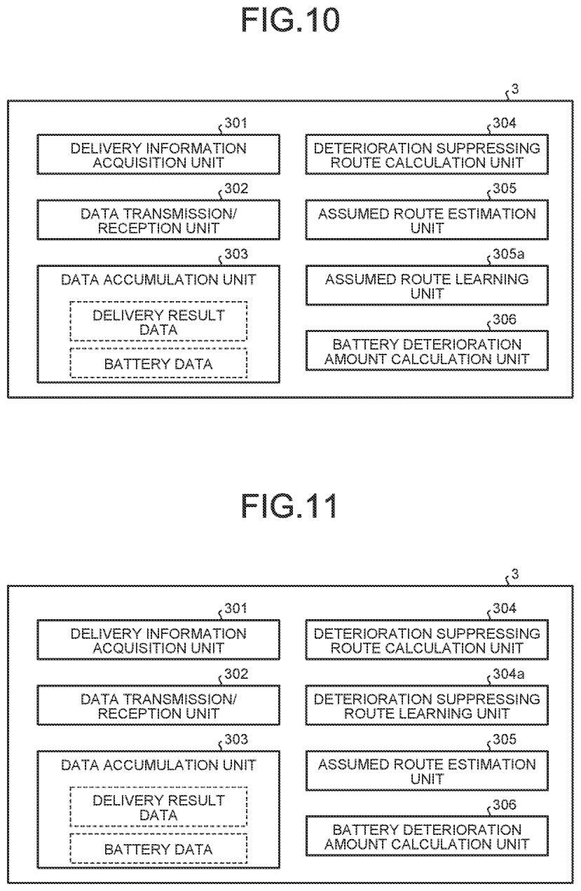

FIG. 10 is a diagram illustrating an example of functions of the delivery route calculation system 3 according to a second modification. As illustrated in FIG. 10, the delivery route calculation system 3 according to the second modification further implements a function as an assumed route learning unit 305a. The assumed route learning unit 305a learns parameters of a machine learning model to output the assumed route in accordance with the input delivery information 4. Specifically, the assumed route learning unit 305a generates data for learning by extracting a pair of the delivery information and the route information of the used delivery route corresponding to the delivery information from the delivery result data 5. Herein, the used delivery route is assumed to be a delivery route that has been actually used by the user in the past. The assumed route learning unit 305a uses the route information of the used delivery route as correct answer data to generate the machine learning model that have learned the parameters so that the assumed route is output in accordance with the input delivery information. The parameters of the machine learning model that have been learned are stored in the memory 32, for example.

At S103 in the delivery route calculation processing illustrated in FIG. 6, the assumed route estimation unit 305 inputs the acquired delivery information 4 to the machine learning model that have learned the parameters so that the assumed route is output in accordance with the input delivery information, and acquires an output of the machine learning model as the assumed route.

In this way, the delivery route display system 1 according to the second modification calculates the assumed route by using the machine learning model. With this configuration, an effect of improving estimation accuracy for the assumed route can be obtained in addition to the effect obtained by the first embodiment.

Third Modification

FIG. 11 is a diagram illustrating an example of functions of the delivery route calculation system according to a third modification. As illustrated in FIG. 11, the delivery route calculation system 3 according to the third modification further implements a function as a deterioration suppressing route learning unit 304a. The deterioration suppressing route learning unit 304a learns parameters of the machine learning model to output the deterioration suppressing route in accordance with the input delivery information 4. Specifically, the deterioration suppressing route learning unit 304a extracts the delivery information from the delivery result data 5. The deterioration suppressing route calculation unit 304 calculates the deterioration suppressing route corresponding to the extracted delivery information. In a case in which the deterioration suppressing route corresponding to each piece of the delivery information is accumulated as the delivery result data 5, the deterioration suppressing route learning unit 304a extracts the delivery information and the deterioration suppressing route from the delivery result data 5. The deterioration suppressing route learning unit 304a generates, as data for learning, a pair of the extracted delivery information and the route information of the extracted or calculated deterioration suppressing route. The deterioration suppressing route learning unit 304a uses the route information of the extracted or calculated deterioration suppressing route as correct answer data, and generates a machine learning model that have learned the parameters so that the deterioration suppressing route is output in accordance with the input delivery information. The parameters of the machine learning model that have been learned are stored in the memory 32, for example.

At S102 in the delivery route calculation processing illustrated in FIG. 6, the deterioration suppressing route calculation unit 304 inputs the acquired delivery information 4 to the machine learning model that have learned the parameters so that the deterioration suppressing route is output in accordance with the input delivery information, and acquires an output from the machine learning model as the deterioration suppressing route.

In this way, the delivery route display system 1 according to the third modification calculates the deterioration suppressing route by using the machine learning model. With this configuration, an effect of improving calculation accuracy for the deterioration suppressing route can be obtained in addition to the effect obtained in the first embodiment.

In the second modification or the third modification, the machine learning model is generated for each driver or each delivery area, for example, but the embodiment is not limited thereto. The machine learning model may be generated for each time zone, each classification such as a weekday, a holiday, or a national holiday, and each type of the battery. Alternatively, two or more of machine learning models may be subjected to ensemble learning, and may be generated as one machine learning model.

In the second modification or the third modification, the machine learning model may be subjected to reinforcement learning by using the acquired delivery information 4 and each of the calculated delivery routes for every time at least the delivery route calculation processing is performed once.

In the second modification or the third modification, the machine learning model is assumed to be a composite function with parameters obtained by combining a plurality of functions, and defined by a combination of a plurality of adjustable functions and parameters. The machine learning model may be any composite function with parameters that is defined by a combination of a plurality of adjustable functions and parameters. The machine learning model may be a convolutional neural network (CNN), or may be a fully coupled network.

Fourth Modification

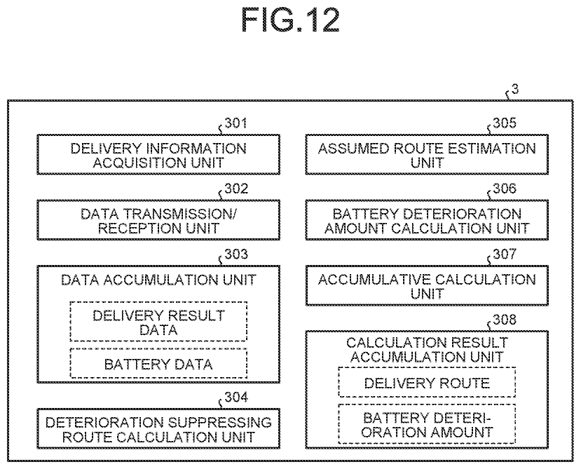

FIG. 12 is a diagram illustrating an example of functions of the delivery route calculation system 3 according to a fourth modification. As illustrated in FIG. 12, the delivery route calculation system 3 according to the fourth modification further implements functions as an accumulative calculation unit 307 and a calculation result accumulation unit 308. The accumulative calculation unit 307 calculates a cumulative value of the battery deterioration amount when assuming that the first traveling route has been used for a predetermined period, and a cumulative value of the battery deterioration amount when assuming that the second traveling route has been used for the predetermined period. Respective cumulative values corresponding to the assumed route and the deterioration suppressing route may be collectively referred to as two cumulative values in some cases. The calculation result accumulation unit 308 accumulates the calculated battery deterioration amounts of the respective delivery routes.

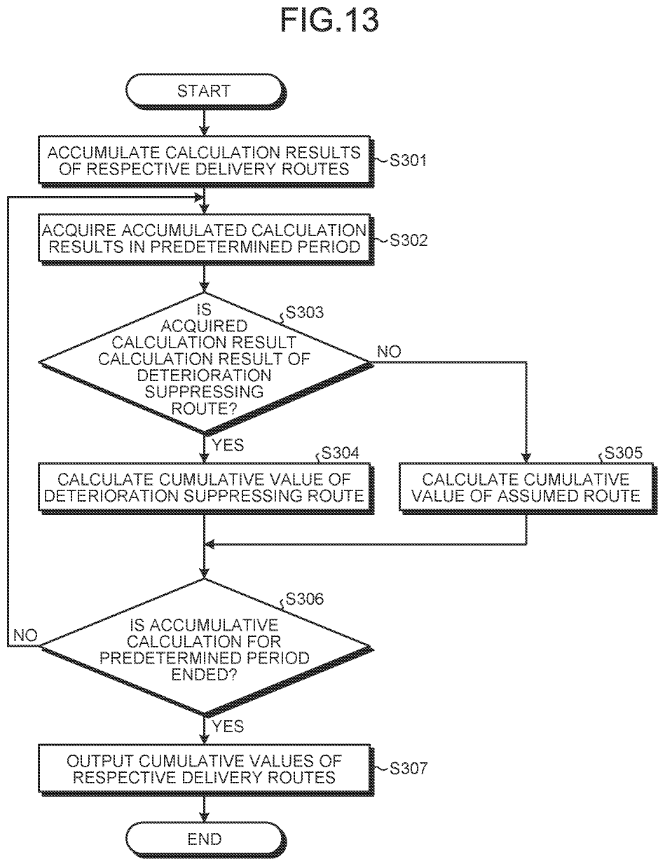

FIG. 13 is a flowchart illustrating an example of evaluation index calculation processing performed by the delivery route calculation system 3 according to the fourth modification. The evaluation index calculation processing corresponds to the processing at S104 in FIG. 6, for example. The calculation result accumulation unit 308 accumulates calculation results of the respective delivery routes, that is, the respective battery deterioration amounts calculated by the deterioration suppressing route calculation unit 304 and the assumed route estimation unit 305 (S301). Subsequently, the accumulative calculation unit 307 acquires the battery deterioration amounts in the predetermined period accumulated by the calculation result accumulation unit 308 (S302). The calculation result accumulation unit 308 determines whether the acquired battery deterioration amount is a calculation result of the deterioration suppressing route (S303), and calculates the cumulative value of the deterioration suppressing route (Yes at S303, S304) or the cumulative value of the assumed route (No at S303, S305). Subsequently, the calculation result accumulation unit 308 determines whether cumulative values has been calculated for all calculation results in the predetermined period (S306). If accumulative calculation for the predetermined period has not been ended (No at S306), the process returns to S302. If accumulative calculation for the predetermined period has been ended (Yes at S306), the calculation result accumulation unit 308 outputs the cumulative value of each of the delivery routes (S307). Subsequently, the evaluation index calculation processing ends, and the data transmission/reception unit 302 outputs the route information indicating the two delivery routes and the cumulative values of the respective delivery routes (S105). The output route information and the cumulative values are supplied to the delivery route display terminal 2.

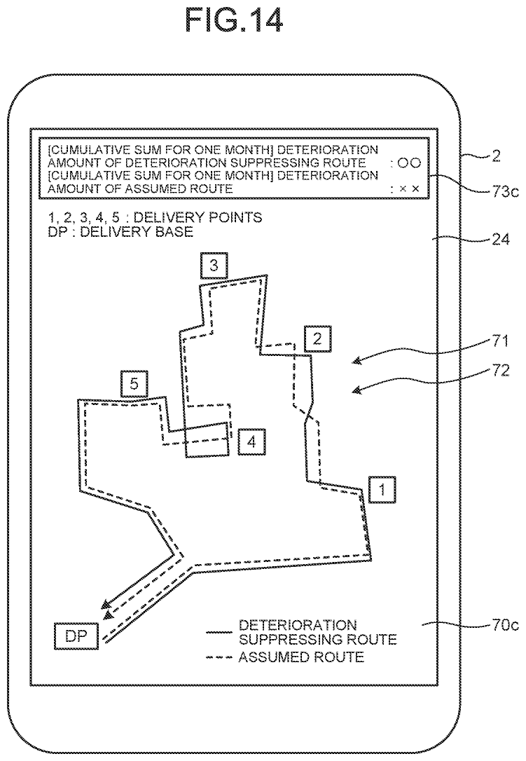

At S202 in the delivery route display processing illustrated in FIG. 7, the display unit 202 displays the two delivery routes and the two cumulative values acquired from the delivery route calculation system 3 by the reception unit 201. FIG. 14 is a diagram illustrating an example of a display screen displayed in the delivery route display processing according to the fourth modification. A display screen 70c in FIG. 14 includes the deterioration suppressing route 71 as the recommended delivery route, and the reference data. The reference data includes the assumed route 72 and evaluation indexes 73c. The evaluation indexes 73c include the cumulative value of the battery deterioration amount of each of the delivery routes. The display screen 70c includes the delivery base DP and a plurality of delivery points.

The battery deterioration amount of the used delivery route that has been actually used by the driver may be accumulated.

The evaluation index calculation processing may be performed by the delivery route display terminal 2.

In this way, the delivery route display system 1 according to the fourth modification uses, as the evaluation indexes, the two cumulative values of the battery deterioration amount when assuming that the respective two traveling routes are used in the predetermined period. With this configuration, a difference between the two cumulative values is larger than a difference between the two battery deterioration amounts, so that an advantage of using the deterioration suppressing route can be emphasized and displayed. In other words, with the technique according to the fourth modification, it is possible to prompt the user to use the deterioration suppressing route more strongly.

As the evaluation indexes, the cumulative value of the battery deterioration amount when assuming that a first delivery route is used for a predetermined period from the present time, and the cumulative value of the battery deterioration amount when assuming that a second delivery route is used for a predetermined period from the present time may be used. The respective cumulative values corresponding to the assumed route and the deterioration suppressing route may be collectively referred to as two cumulative values in some cases. In this case, the accumulative calculation unit 307 calculates, as the cumulative value, the battery deterioration amount of each expected route based on the calculated battery deterioration amount of each route and a work schedule or a work history of the driver. By way of example, the accumulative calculation unit 307 calculates the cumulative value by multiplying the calculated battery deterioration amount of each route by the number of days of delivery performed by the driver. In this case, the delivery route is congested or the number of cargos is large in national holidays, so that calculation of further multiplying a predetermined coefficient larger than 1 by the battery deterioration amount can be appropriately used. The predetermined coefficient may be calculated in advance based on the delivery result data 5, and stored in the memory 32 and the like, for example. In this way, when using the evaluation indexes including the two cumulative values of the battery deterioration amount when assuming that the two respective traveling route are used for the predetermined period, the same effect as that of the fourth modification can be obtained.

Fifth Modification

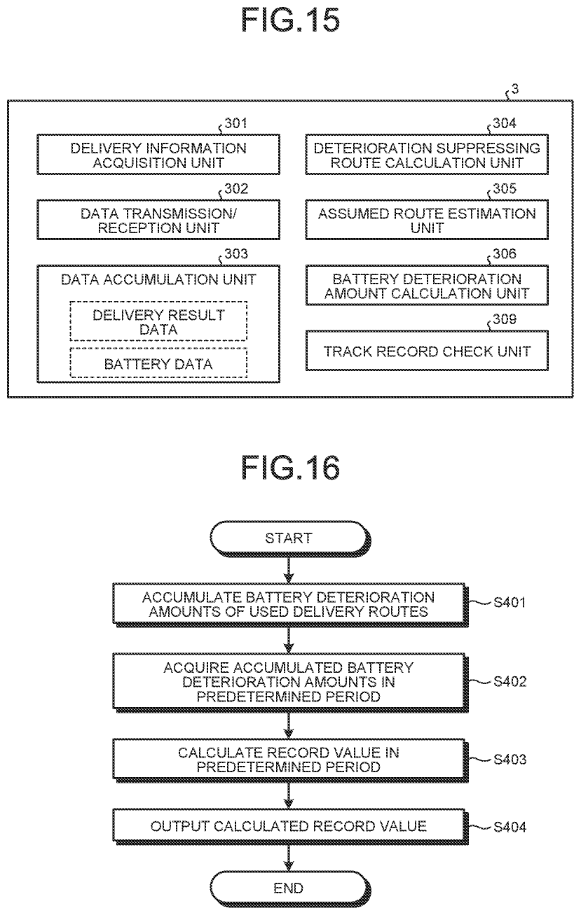

FIG. 15 is a diagram illustrating an example of functions of the delivery route calculation system 3 according to a fifth modification. As illustrated in FIG. 15, the delivery route calculation system 3 according to the fifth modification further implements a function as a track record check unit 309. The track record check unit 309 executes calculation for checking a record value of the battery deterioration amount of the driver based on the accumulated battery deterioration amount of the used delivery route. The accumulated battery deterioration amount of the used delivery route is an example of traveling history data of the driver.

FIG. 16 is a flowchart illustrating an example of evaluation index calculation processing performed by the delivery route calculation system according to the fifth modification. The evaluation index calculation processing corresponds to the processing at S104 in FIG. 6, for example. The data accumulation unit 303 accumulates the battery deterioration amount of the used delivery route (S401). The processing at S401 is assumed to be performed before the processing at S104 in FIG. 6 at a predetermined timing, for example, for each time of delivery, for each delivery date, and the like. As the battery deterioration amount of the used delivery route, in a case in which any of the assumed route and the deterioration suppressing route is used, a calculation result related to the used delivery route may be used. In a case in which the used delivery route is different from the two delivery routes, the battery deterioration amount of the used delivery route may be calculated by the battery deterioration amount calculation unit 306, and the calculated battery deterioration amount may be accumulated. The track record check unit 309 acquires the battery deterioration amount of the used delivery route in the predetermined period accumulated by the data accumulation unit 303 (S402). The track record check unit 309 executes calculation for checking a record value of the battery deterioration amount in the predetermined period by adding up the acquired battery deterioration amounts (S403). The track record check unit 309 outputs the calculated record value to the data transmission/reception unit 302 (S404). Thereafter, the evaluation index calculation processing ends, and the data transmission/reception unit 302 outputs the route information indicating the two delivery routes and the record value of the used delivery route (S105). The output route information and record value are supplied to the delivery route display terminal 2.

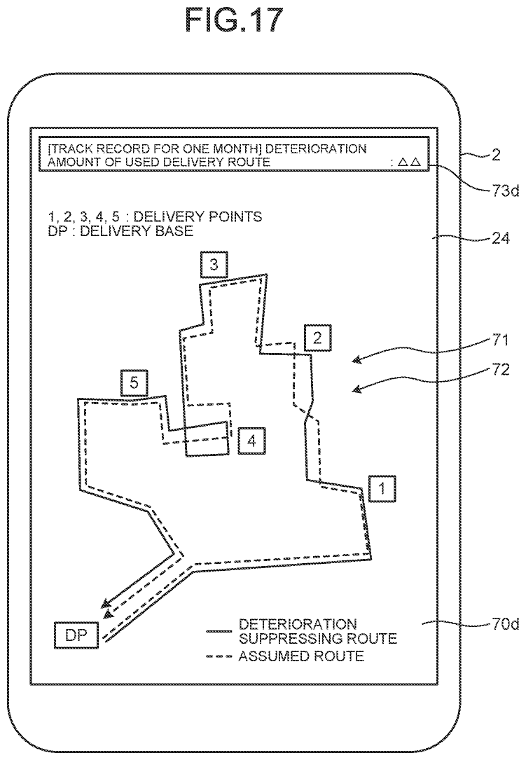

At S202 in the delivery route display processing illustrated in FIG. 7, the display unit 202 displays the two delivery routes and the record value acquired from the delivery route calculation system 3 by the reception unit 201. FIG. 17 is a diagram illustrating an example of a display screen displayed in the delivery route display processing according to the fifth modification. A display screen 70d in FIG. 17 includes the deterioration suppressing route 71 as the recommended delivery route, and the reference data. The reference data includes the assumed route 72 and an evaluation index 73d. The evaluation index 73d includes the record value of the battery deterioration amount of the used delivery route. The display screen 70d further includes the delivery base DP and a plurality of delivery points.

In this way, the delivery route display system 1 according to the fifth modification uses, as the evaluation index, the record value of the battery deterioration amount that is calculated based on the used delivery route that has been actually used by the user for the predetermined period up to the present time. With this configuration, the delivery driver can quantitatively grasp the battery deterioration amount of the delivery route that has been used for the predetermined period up to the present time, so that the delivery driver is motivated to use the recommended deterioration suppressing route in a case in which the battery deterioration amount is large, for example. In other words, with the technique according to the fifth modification, it is possible to prompt the user to use the deterioration suppressing route.

Sixth Modification

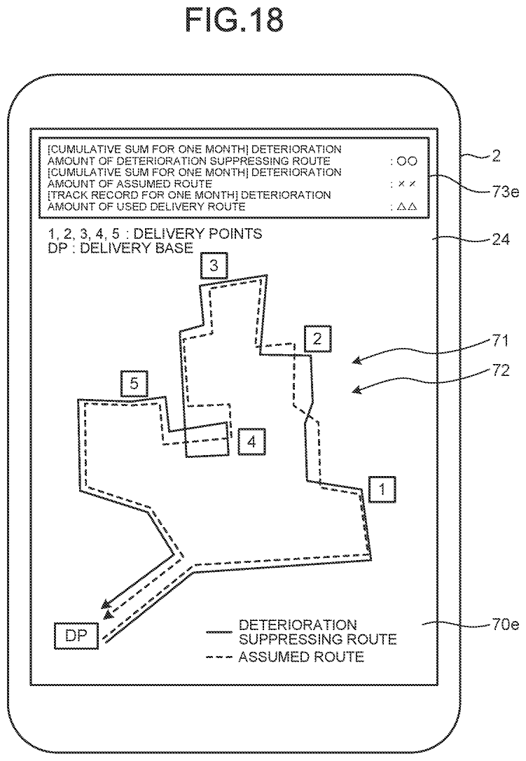

FIG. 18 is a diagram illustrating an example of a display screen displayed in delivery route display processing according to a sixth modification. A display screen 70e in FIG. 18 includes the deterioration suppressing route 71 as the recommended delivery route, and the reference data. The reference data includes the assumed route 72 and evaluation indexes 73e. The evaluation indexes 73e include the cumulative value of the battery deterioration amount of each of the deterioration suppressing route 71 and the assumed route 72, and the record value of the battery deterioration amount of the used delivery route. In other words, the evaluation indexes 73e according to the sixth modification exemplified in FIG. 18 include the evaluation indexes 73c according to the fourth modification exemplified in FIG. 14, and the evaluation index 73d according to the fifth modification in FIG. 17. The display screen 70e further includes the delivery base DP and a plurality of delivery points.

In this way, the delivery route display system 1 according to the sixth modification uses, as evaluation indexes, the two cumulative values of the battery deterioration amount when assuming that the respective two traveling routes are used for the predetermined period, and the record value of the battery deterioration amount that is calculated based on the used delivery route that has been actually used by the user for the predetermined period up to the present time. That is, the delivery route display system 1 according to the fourth modification and the delivery route display system 1 according to the fifth modification can be combined with each other. Similarly to the fourth modification, as the cumulative value, the cumulative value of each battery deterioration amount when assuming that each delivery route is used for the predetermined period from the present time may be used.

Seventh Modification

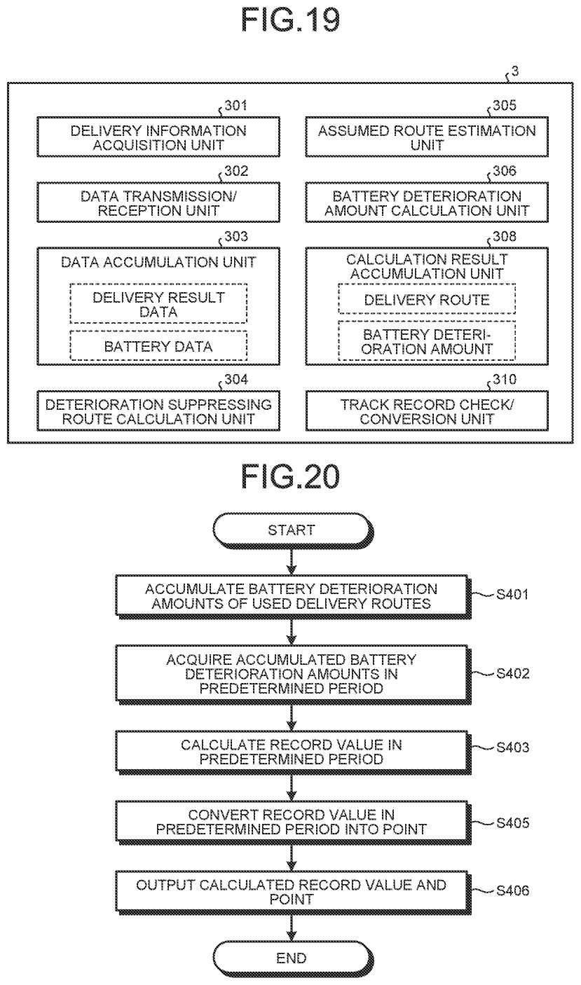

FIG. 19 is a diagram illustrating an example of functions of the delivery route calculation system 3 according to a seventh modification. As illustrated in FIG. 19, the delivery route calculation system 3 according to the seventh modification further implements functions as a calculation result accumulation unit 308 and a track record check/conversion unit 310. The calculation result accumulation unit 308 is the same as the calculation result accumulation unit 308 according to the fourth modification exemplified in FIG. 12, and accumulates the calculated battery deterioration amount of each of the delivery routes. Similarly to the track record check unit 309 according to the fifth modification exemplified in FIG. 15, the track record check/conversion unit 310 executes calculation for checking a record value of the battery deterioration amount of the driver based on the accumulated battery deterioration amount of the used delivery route. The track record check/conversion unit 310 also calculates a point corresponding to the calculated record value. The point is an example of privilege information.

FIG. 20 is a flowchart illustrating an example of evaluation index calculation processing performed by the delivery route calculation system 3 according to the seventh modification. The following describes differences from the evaluation index calculation processing according to the fifth modification exemplified in FIG. 16. After executing calculation for checking the record value of the battery deterioration amount in the predetermined period (S403), the track record check/conversion unit 310 converts the calculated record value into the point (S405). For example, the track record check/conversion unit 310 calculates a higher point as the record value is smaller. A conversion rate from the record value into the point is, for example, set in advance and stored in the memory 32 and the like. Thereafter, the track record check/conversion unit 310 outputs the calculated record value and the point to the data transmission/reception unit 302 (S406). Subsequently, the evaluation index calculation processing ends, and the data transmission/reception unit 302 outputs the route information indicating the two delivery routes, the record value of the used delivery route, and the point corresponding to the record value (S105). The output route information, track record value, and point are supplied to the delivery route display terminal 2.

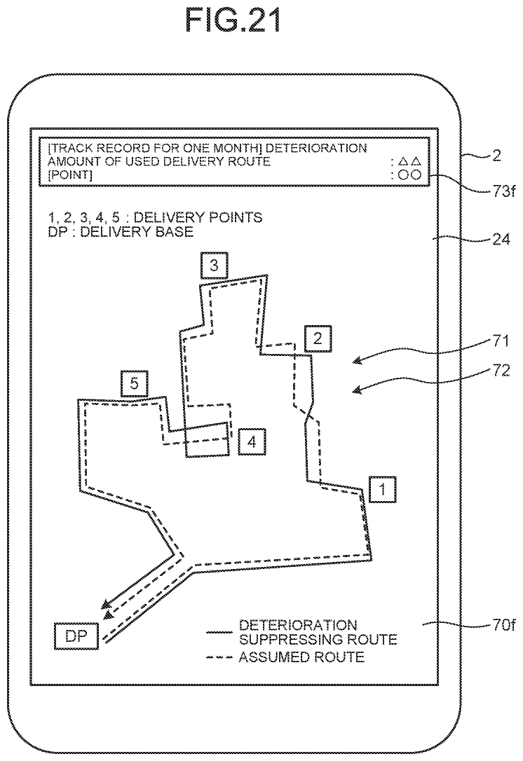

At S202 in the delivery route display processing illustrated in FIG. 7, the display unit 202 displays the two delivery routes, the record value, and the point acquired from the delivery route calculation system 3 by the reception unit 201. FIG. 21 is a diagram illustrating an example of a display screen displayed in delivery route display processing according to the seventh modification. A display screen 70f in FIG. 21 includes the deterioration suppressing route 71 as the recommended delivery route, and the reference data. The reference data includes the assumed route 72 and evaluation indexes 73f. The evaluation indexes 73f include the record value of the battery deterioration amount of the used delivery route, and the point converted from the record value. The display screen 70f further includes the delivery base DP and a plurality of delivery points.

In this way, the delivery route display system 1 according to the seventh modification displays, as the evaluation index, the point that is given in accordance with the record value. With this configuration, the user can actually feel an effect of using the deterioration suppressing route in view of deterioration of the battery. The point is given in accordance with the record value, so that the user actively uses the deterioration suppressing route. That is, the technique according to the seventh modification can improve an effect of prompting the user to use the deterioration suppressing route.

The technique according to the seventh modification can be applied to the fourth to the sixth modifications. That is, in the evaluation index calculation processing, the point may be calculated in accordance with the cumulative value instead of the record value, or may be calculated in accordance with the cumulative value and the record value. With these configurations, the same effect as that of the delivery route display system 1 according to the seventh modification can be obtained.

In the fourth to the seventh modifications, the delivery route display system according to each of the modifications has been described while exemplifying a case in which the predetermined period is set to be one month, but the embodiment is not limited thereto. As the predetermined period, an optional period such as one week, two weeks, six months, or one year can be appropriately set. The predetermined period may be set in advance and stored in the memory 32 and the like, or may be set in accordance with an input result to the delivery route display terminal 2 by the user.

As the evaluation index, information on at least one of a time, a distance, and a congestion state related to each of the delivery routes can be appropriately used. Specifically, the deterioration suppressing route calculation unit 304 calculates an estimated arrival time for each delivery address, a time between continuous delivery addresses, a total delivery time, a distance between continuous delivery addresses, a total delivery distance, a congestion state on the route, and the like for each of the delivery routes based on the delivery information 4 and the delivery result data 5. With this configuration, the same effect as that of the delivery route display system 1 according to the first embodiment and the respective modifications can be obtained.

The evaluation index may be presented to a manager of the delivery vehicle instead of the delivery driver. That is, the delivery route calculation system 3 may further include a display that displays the evaluation indexes. As the evaluation indexes displayed by the delivery route calculation system 3, evaluation indexes as follows can be appropriately used instead of the evaluation indexes described above.

For example, as the evaluation indexes presented to the manager, a selection rate of the deterioration suppressing route for each delivery driver can be appropriately used. In this case, the delivery route display terminal 2 or the delivery route calculation system 3 further implements a function as a delivery driver evaluation unit that calculates the selection rate indicating a ratio of selection of the deterioration suppressing route from the calculated deterioration suppressing route and assumed route based on the delivery result data 5.

For example, as the evaluation indexes presented to the manager, a control rate of the battery deterioration amount for each delivery driver can be appropriately used. In this case, the delivery route display terminal 2 or the delivery route calculation system 3 further implements a function as a delivery driver evaluation unit that calculates a control rate of the battery deterioration amount based on the delivery result data 5. As the control rate of the battery deterioration amount, used is a ratio of the record value of the battery deterioration amount to the battery deterioration amount when using only the assumed route for the predetermined period, for example.

For example, as the evaluation index presented to the manager, a control amount of the battery deterioration amount for each delivery driver can be appropriately used. In this case, the delivery route display terminal 2 or the delivery route calculation system 3 further implements a function as a delivery driver evaluation unit that calculates the control amount of the battery deterioration amount based on the delivery result data 5. As the control amount of the battery deterioration amount, used is a total value of the battery deterioration record amount related to the used delivery route that has been actually used for the predetermined period, for example.

### Second Embodiment

For example, a plurality of delivery routes may be calculated so that profits of a plurality of delivery areas are improved as a whole. The profits herein include, for example, suppression of battery deterioration, reduction of delivery time, and the like. Thus, unlike a case in which the recommended delivery route is calculated for one delivery area, a delivery route passing through a delivery area of another vehicle may be recommended as an own vehicle delivery route in some cases. That is, the own vehicle delivery route may be changed in accordance with delivery information of at least one adjacent delivery area in some cases. In such a case, the user cannot determine whether the suggested delivery route is appropriate even if the recommended delivery route is simply suggested. Specifically, there has been a case in which the user cannot eliminate a sense of unfairness with respect to another delivery area, and cannot be convinced of using the suggested delivery route. In the case in which the user does not select the recommended delivery route because the user is unconvinced or other reasons, the profits of the areas as a whole are lost such that deterioration of the battery cannot be suppressed.

The technique according to the second embodiment provides a display terminal, a display system, and a display method that can prompt the user to use the recommended delivery route.

Specifically, the display system according to the second embodiment is a system that presents, to the user, the own vehicle delivery route that is recommended to be used together with reference data as a standard for evaluating the own vehicle delivery route. Herein, the reference data includes a second vehicle delivery route that is a delivery route of a second vehicle related to at least one adjacent area as a comparison target. The reference data can be expressed as information for prompting the user to use the own vehicle delivery route, that is, the recommended delivery route.

More specifically, the display system according to the second embodiment is a system that calculates a plurality of delivery routes for suppressing battery deterioration related to a plurality of vehicles, and displays the own vehicle delivery route and at least one second vehicle delivery route among the delivery routes in a comparable manner. In the display system, the display terminal displays the own vehicle delivery route and at least one second vehicle delivery route in a comparable manner.

The own vehicle delivery route is an example of the first traveling route related to the own vehicle that is recommended to be used. The second vehicle delivery route is an example of the second traveling route related to the second vehicle that is displayed as the reference data. The own vehicle delivery area is an example of a traveling area of the own vehicle. The second vehicle delivery area is an example of a traveling area of the second vehicle adjacent to the own vehicle delivery area.

The following describes the display terminal, the display system, and the display method according to the second embodiment in more detail. The following mainly describes differences from the first embodiment, and redundant description will be appropriately omitted.

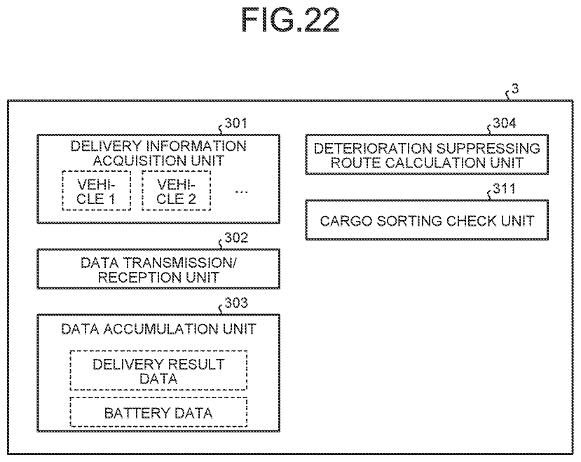

FIG. 22 is a diagram illustrating an example of functions of the delivery route calculation system 3 according to the second embodiment. As illustrated in FIG. 22, the delivery route calculation system 3 includes functions as the delivery information acquisition unit 301, the data transmission/reception unit 302, the data accumulation unit 303, the deterioration suppressing route calculation unit 304, and a cargo sorting check unit 311. The delivery information acquisition unit 301 acquires the delivery information 4 related to a plurality of vehicles. The data transmission/reception unit 302 and the data accumulation unit 303 are the same as the data transmission/reception unit 302 and the data accumulation unit 303 according to the first embodiment. The deterioration suppressing route calculation unit 304 calculates a plurality of delivery routes for suppressing battery deterioration related to the vehicles. The cargo sorting check unit 311 determines whether a cargo addressed to a delivery address in a second vehicle delivery area adjacent to the own vehicle delivery area is present on the own vehicle delivery route. The cargo sorting check unit 311 also extracts a delivery route to be presented to the user from among a plurality of deterioration suppressing routes of a plurality of delivery areas in accordance with a determination result.

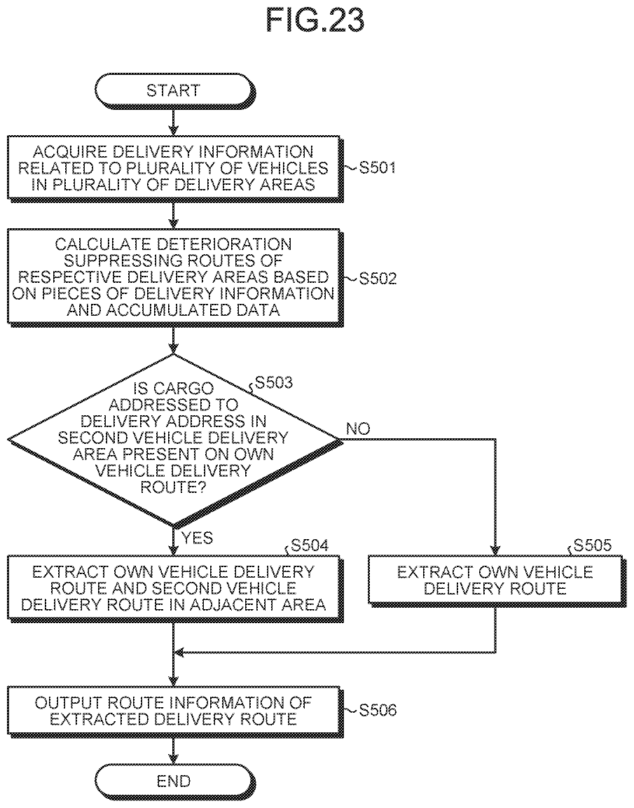

FIG. 23 is a flowchart illustrating an example of delivery route calculation processing performed by the delivery route calculation system 3 according to the second embodiment.

First, the delivery information acquisition unit 301 acquires, from the database, the delivery information 4 related to a plurality of vehicles in a plurality of delivery areas (S501). Thereafter, the deterioration suppressing route calculation unit 304 calculates a plurality of deterioration suppressing routes for the delivery areas based on a plurality of pieces of the delivery information 4 and the battery data 6 (S502). The battery data 6 is assumed to be received from the database by the data transmission/reception unit 302, and accumulated by the data accumulation unit 303 before the processing at 3502.

The delivery route calculation system 3 according to the second embodiment may further have a function as the battery deterioration amount calculation unit 306 according to the first embodiment. In this case, the deterioration suppressing route calculation unit 304 may supply the delivery information 4 and the battery data 6 to the battery deterioration amount calculation unit 306, and calculate the deterioration suppressing route based on an output from the battery deterioration amount calculation unit 306 corresponding to the delivery information 4 and the battery data 6. The deterioration suppressing route calculation unit 304 and the battery deterioration amount calculation unit 306 may be configured as one function. Similarly to the delivery route calculation system 3 according to the first embodiment, the battery deterioration amount of each of the delivery routes may be further calculated.

The cargo sorting check unit 311 determines whether a cargo addressed to a delivery address in the second vehicle delivery area adjacent to the own vehicle delivery area is present on the own vehicle delivery route among the deterioration suppressing routes calculated by the deterioration suppressing route calculation unit 304 (S503). When the cargo addressed to the delivery address in the second vehicle delivery area adjacent to the own vehicle delivery area is present on the own vehicle delivery route (Yes at S503), the cargo sorting check unit 311 extracts, from among the deterioration suppressing routes, the own vehicle delivery route and the second vehicle delivery route in at least one second vehicle delivery area adjacent to the own vehicle delivery area (S504). On the other hand, when the cargo addressed to the delivery address in the second vehicle delivery area adjacent to the own vehicle delivery area is not present on the own vehicle delivery route (No at S503), the cargo sorting check unit 311 extracts the own vehicle delivery route from among the deterioration suppressing routes (S505). After the processing at S504 or 3505, the data transmission/reception unit 302 outputs route information indicating the extracted deterioration suppressing route (S506). The output route information is supplied to the delivery route display terminal 2.

In the delivery route display processing illustrated in FIG. 7, when the cargo addressed to the delivery address in the second vehicle delivery area is not present on the own vehicle delivery route, the reception unit 201 acquires the route information indicating the own vehicle delivery route from the delivery route calculation system 3 (S201). Thereafter, the display unit 202 displays the acquired own vehicle delivery route.

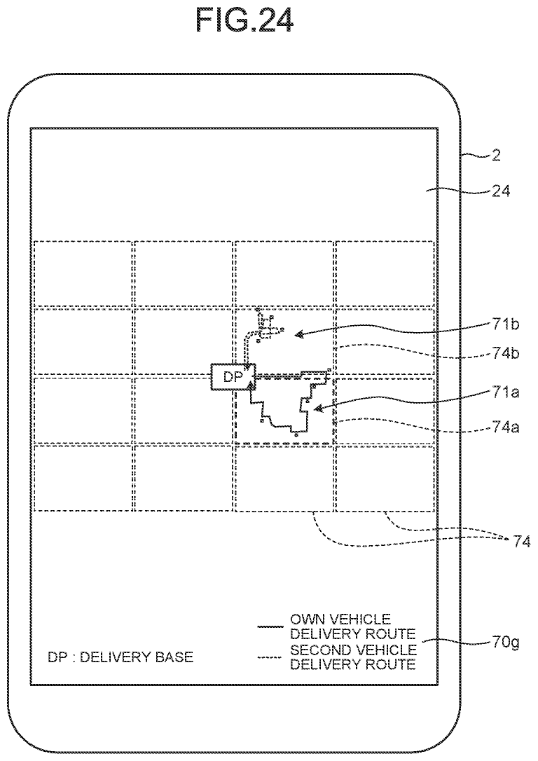

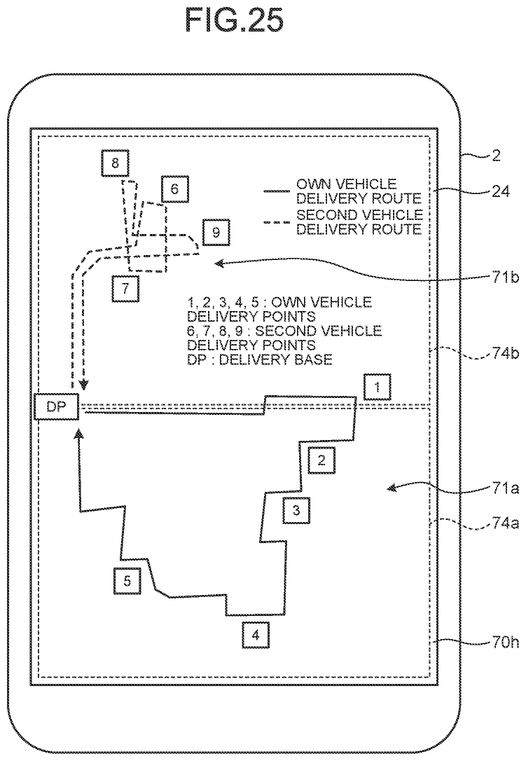

On the other hand, when the cargo addressed to the delivery address in the second vehicle delivery area is present on the own vehicle delivery route, the reception unit 201 acquires the route information indicating the own vehicle delivery route and at least one second vehicle delivery route from the delivery route calculation system 3. Thereafter, the display unit 202 displays the acquired own vehicle delivery route and at least one second vehicle delivery route in a comparable manner. FIG. 24 and FIG. 25 are diagrams illustrating an example of a display screen displayed in the delivery route display processing according to the second embodiment. A display screen 70g in FIG. 24 and a display screen 70h in FIG. 25 each include an own vehicle delivery route 71a as the recommended delivery route, and the reference data. The reference data includes a second vehicle delivery route 71b in a second vehicle delivery area 74b adjacent to an own vehicle delivery area 74a, the second vehicle delivery route 71b displayed to be comparable with the own vehicle delivery route 71a. The display screen 70g and the display screen 70h each further include the delivery base DP and a plurality of delivery points. A plurality of delivery areas 74 are displayed on the display screen 70g exemplified in FIG. 24. The user can easily check the delivery area from which the cargo is received, or to which the cargo is transferred. For example, the user makes a transition from the display screen 70g to the display screen 70h exemplified in FIG. 25 by performing various operations such as tapping, pinching, or swiping the own vehicle delivery area 74a or the adjacent second vehicle delivery area 74b. On the display screen 70h exemplified in FIG. 25, the own vehicle delivery area 74a and the second vehicle delivery area 74b from which the cargo is received or to which the cargo is transferred among the second vehicle delivery areas 74b adjacent to the own vehicle delivery area 74a are displayed in an enlarged manner. The user can compare the own vehicle delivery route 71a with the second vehicle delivery route 71b in detail.

In this way, the delivery route display system 1 according to the second embodiment displays the reference data together with the own vehicle delivery route that is recommended to be used. Specifically, the own vehicle delivery route is a deterioration suppressing route related to the own vehicle among the deterioration suppressing routes for suppressing battery deterioration related to a plurality of vehicles, the deterioration suppressing route calculated based on the delivery information 4 related to a plurality of delivery addresses and the accumulated battery data 6. The reference data includes at least one second vehicle delivery route. The at least one second vehicle delivery route is a deterioration suppressing route related to the second vehicle in at least one second vehicle delivery area among the deterioration suppressing routes. The at least one second vehicle delivery area is at least one delivery area adjacent to the own vehicle delivery area as a delivery area of the own vehicle. The own vehicle delivery route and at least one second vehicle delivery route are displayed in a comparable manner.

With this configuration, the user can determine whether the own vehicle delivery route is appropriate based on the reference data. In other words, the user can determine whether the recommended own vehicle delivery route is appropriate based on the own vehicle delivery route and at least one second vehicle delivery route that are displayed in a comparable manner. Due to this, the user can eliminate a sense of unfairness with respect to the adjacent second vehicle delivery area, so that the user can be convinced of using the suggested own vehicle delivery route. The convinced user can select the recommended delivery route without a feeling of resistance. That is, the delivery route display system 1 according to the second embodiment can prompt the user to use the recommended own vehicle delivery route.

In the processing at S503 of the delivery route calculation processing according to the second embodiment, there may be a case in which it is determined whether the cargo addressed to the delivery address in the own vehicle delivery area is present on the second vehicle delivery route in the second vehicle delivery area adjacent to the own vehicle delivery area. This determination may be performed in place of the determination according to the embodiment described above, or may be performed along with the determination according to the embodiment described above. Specifically, in the delivery route display processing illustrated in FIG. 7, when the cargo addressed to the delivery address in the own vehicle delivery area is not present on the second vehicle delivery route, the reception unit 201 acquires the route information indicating the own vehicle delivery route from the delivery route calculation system 3 (S201). Thereafter, the display unit 202 displays the acquired own vehicle delivery route. On the other hand, when the cargo addressed to the delivery address in the own vehicle delivery area is present on the second vehicle delivery route, the reception unit 201 acquires, from the delivery route calculation system 3, the route information indicating the own vehicle delivery route and at least one second vehicle delivery route. Thereafter, the display unit 202 displays the acquired own vehicle delivery route and at least one second vehicle delivery route in a comparable manner. With this configuration, the same effect as that of the delivery route display system 1 according to the second embodiment can be obtained.

When the cargo addressed to the delivery address in the second vehicle delivery area adjacent to the own vehicle delivery area is not present on the own vehicle delivery route (No at S503), the second vehicle delivery route in the second vehicle delivery area adjacent to the own vehicle delivery area may be further extracted from the deterioration suppressing routes instead of the own vehicle delivery route. With this configuration, the own vehicle delivery route and the second vehicle delivery route are displayed in a comparable manner irrespective of presence/absence of a delivery route passing through a plurality of delivery areas, so that the user can check the own vehicle delivery route and the second vehicle delivery route in the adjacent delivery area at all times.

The following describes modifications of the second embodiment. The following mainly describes differences from the second embodiment, and redundant description will be appropriately omitted.

Eighth Modification

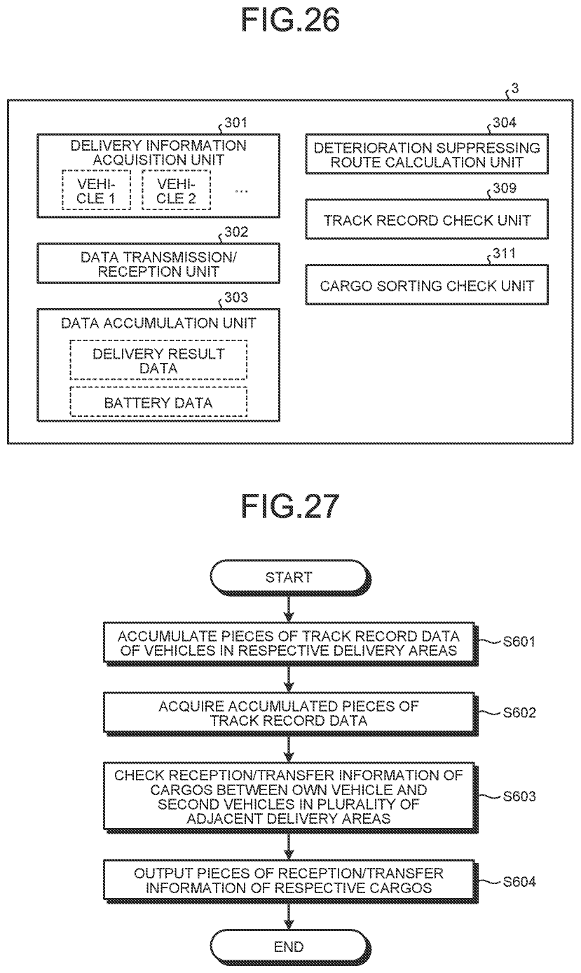

FIG. 26 is a diagram illustrating an example of functions of the delivery route calculation system 3 according to an eighth modification. As illustrated in FIG. 26, the delivery route calculation system 3 according to the eighth modification further implements a function as the track record check unit 309. The track record check unit 309 according to the eighth modification checks reception/transfer information of the cargo between adjacent delivery areas based on the delivery information 4 of the accumulated used delivery routes. The reception/transfer information of the cargo between the adjacent delivery areas is an example of destination information, and corresponds to the evaluation index according to the first embodiment. Specifically, the reception information of the cargo with the adjacent delivery areas is information indicating the delivery address in the second vehicle delivery area on the own vehicle delivery route or the cargo addressed to the delivery address. The transfer information of the cargo with the adjacent delivery areas is information indicating the delivery address in the own vehicle delivery area on the second vehicle delivery route or the cargo addressed to the delivery address.

FIG. 27 is a flowchart illustrating an example of evaluation index calculation processing performed by the delivery route calculation system according to the eighth modification. The data accumulation unit 303 accumulates track record data of reception/transfer of cargos for vehicles in the respective delivery areas (S601). The track record data of reception/transfer of cargos for vehicles in the respective delivery areas is accumulated as delivery result data, for example. The processing at S601 is assumed to be performed subsequent to the processing at S502 in FIG. 23, for example. On the other hand, the following pieces of processing at S602 to S604 are assumed to be performed subsequent to the processing at S504 in FIG. 23, for example. The track record check unit 309 acquires pieces of the track record data accumulated by the data accumulation unit 303 (S602). The track record check unit 309 checks reception/transfer information of cargos between the own vehicle and the second vehicles in the second vehicle delivery areas adjacent to the own vehicle delivery area (S603). Specifically, the track record check unit 309 acquires the own vehicle delivery route and at least one second vehicle delivery route extracted by the cargo sorting check unit 311 (S504), and checks the reception/transfer information of cargos among the delivery areas. Thereafter, the track record check unit 309 outputs the checked reception/transfer information of cargos to the data transmission/reception unit 302 (S604). Thereafter, the evaluation index calculation processing ends, and the data transmission/reception unit 302 outputs pieces of the reception/transfer information of the respective cargos in addition to the route information indicating the own vehicle delivery route and at least one second vehicle delivery route (S506). The output route information and pieces of the reception/transfer information of the cargos are supplied to the delivery route display terminal 2.

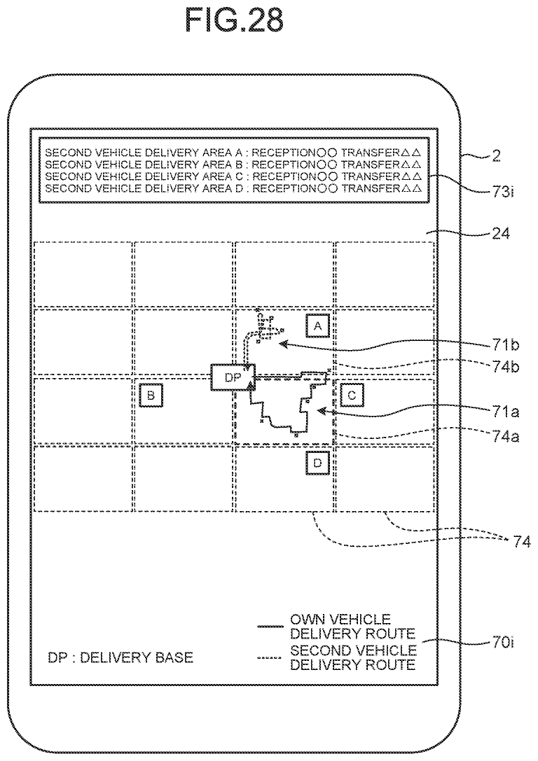

In the delivery route display processing illustrated in FIG. 7, when the cargo addressed to the delivery address in the second vehicle delivery area is present on the own vehicle delivery route, the reception unit 201 acquires the route information indicating the own vehicle delivery route, and the reference data from the delivery route calculation system 3. The reference data includes the route information indicating at least one second vehicle delivery route, and the evaluation indexes. The evaluation indexes include pieces of the reception/transfer information of the respective cargos. Thereafter, the display unit 202 displays the acquired own vehicle delivery route and at least one second vehicle delivery route in a comparable manner, and displays the acquired evaluation indexes. FIG. 28 is a diagram illustrating an example of a display screen displayed in the delivery route display processing according to the eighth modification. A display screen 70i exemplified in FIG. 28 includes the delivery areas 74 and the delivery base DP. The display screen 70i includes the own vehicle delivery route 71a as the recommended delivery route, and the reference data. The reference data includes the second vehicle delivery route 71b in the second vehicle delivery area 74b adjacent to the own vehicle delivery area 74a that is displayed to be comparable with the own vehicle delivery route 71a. The reference data further includes evaluation indexes 73i. The evaluation indexes 73i are pieces of the reception/transfer information of the cargos.

In this way, the delivery route display system 1 according to the eighth modification displays the acquired own vehicle delivery route and at least one second vehicle delivery route in a comparable manner, and further displays the acquired evaluation indexes. With this configuration, the delivery driver can check the reception/transfer information of the cargos between the own vehicle delivery area and the second vehicle delivery area, so that a larger number of determination criteria for comparing the recommended own vehicle delivery route with the second vehicle delivery route in the adjacent other delivery area can be obtained. Due to this, the user can eliminate a sense of unfairness with respect to the adjacent second vehicle delivery area more easily. That is, the delivery route display system 1 according to the eighth modification can improve the effect of prompting the user to use the recommended own vehicle delivery route.

As the evaluation index, a ratio between the number of received cargos and the number of transferred cargos between the own vehicle delivery area and the second vehicle delivery area can be appropriately used. Specifically, a change rate indicating a ratio between the number of delivery addresses in the vehicle delivery area on the own vehicle delivery route and the number of delivery addresses in the own vehicle delivery area on the second vehicle delivery route may be used as the evaluation index. With this configuration, the same effect as that of the delivery route display system 1 according to the eighth modification can be obtained.

As the evaluation index, a usage rate of the recommended own vehicle delivery route of each delivery driver can be appropriately used. Specifically, the track record check unit 309 calculates the usage rate indicating a ratio at which each delivery driver uses the recommended own vehicle delivery route, based on the delivery result data 5. With this configuration, the same effect as that of the delivery route display system 1 according to the eighth modification can be obtained.

As the evaluation index, the evaluation indexes according to the embodiments and the modifications described above can be appropriately used instead of the information described above.

Ninth Modification

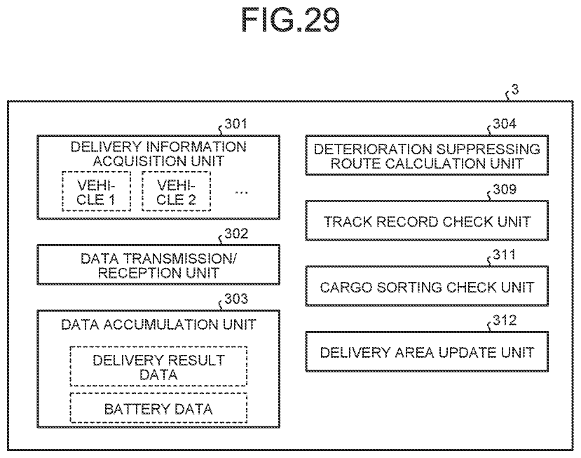

FIG. 29 is a diagram illustrating an example of functions of the delivery route calculation system 3 according to a ninth modification. As illustrated in FIG. 29, the delivery route calculation system 3 according to the ninth modification further implements functions as the track record check unit 309 and a delivery area update unit 312. The track record check unit 309 is the same as the track record check unit 309 according to the eighth modification. The delivery area update unit 312 determines whether the delivery address of a cargo to be received/delivered has been caused to be reception/transfer target at a rate equal to or more than a predetermined rate based on the reception/transfer information checked by the track record check unit 309. The delivery address of the cargo to be received/transferred is an example of a specific destination among a plurality of destinations. The predetermined rate is, for example, set in advance and stored in the memory 32 and the like.

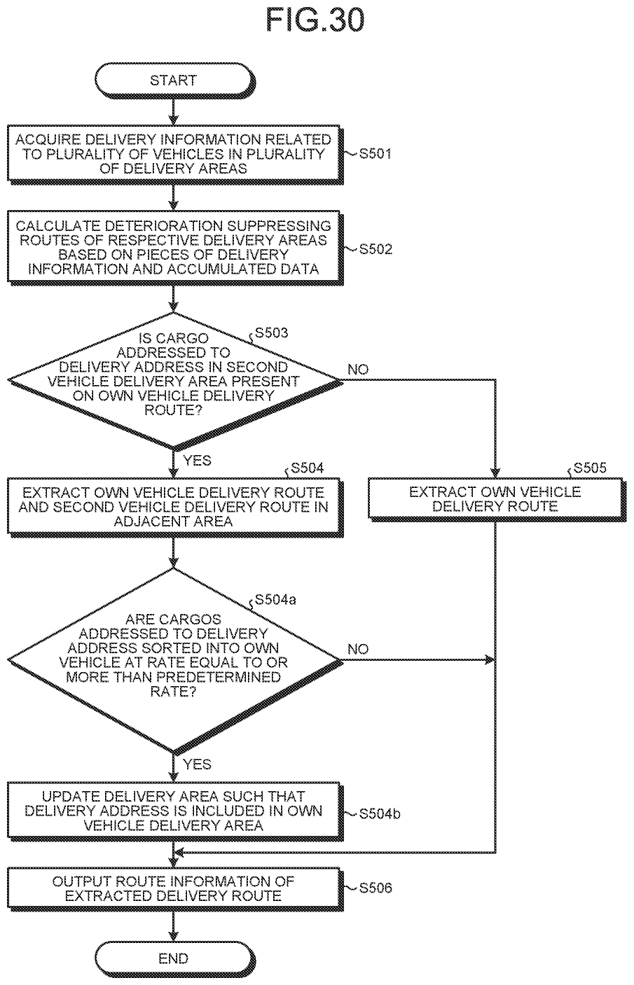

FIG. 30 is a flowchart illustrating an example of delivery route calculation processing performed by the delivery route calculation system 3 according to the ninth modification. The following mainly describes differences from the delivery route calculation processing exemplified in FIG. 23. After the delivery routes of the own vehicle and the second vehicle are extracted (S504), the delivery area update unit 312 determines whether cargos addressed to the delivery address in the second vehicle delivery area on the own vehicle delivery route are sorted into the own vehicle at a rate equal to more than a predetermined rate (S504a). In other words, the delivery area update unit 312 determines whether the delivery addresses of cargos to be received are present on the own vehicle delivery route at a rate equal to more than the predetermined rate. If the delivery addresses of cargos to be received are present on the own vehicle delivery route at a rate equal to or more than the predetermined rate (Yes at S504a), the delivery area update unit 312 updates the respective delivery areas so that the delivery addresses are included in the own vehicle delivery area (S504b). If the delivery addresses of cargos to be transferred are not present on the second vehicle delivery route at a rate equal to or more than the predetermined rate (No at S504a), the data transmission/reception unit 302 outputs the route information indicating the extracted deterioration suppressing route (S506). The output route information is supplied to the delivery route display terminal 2.

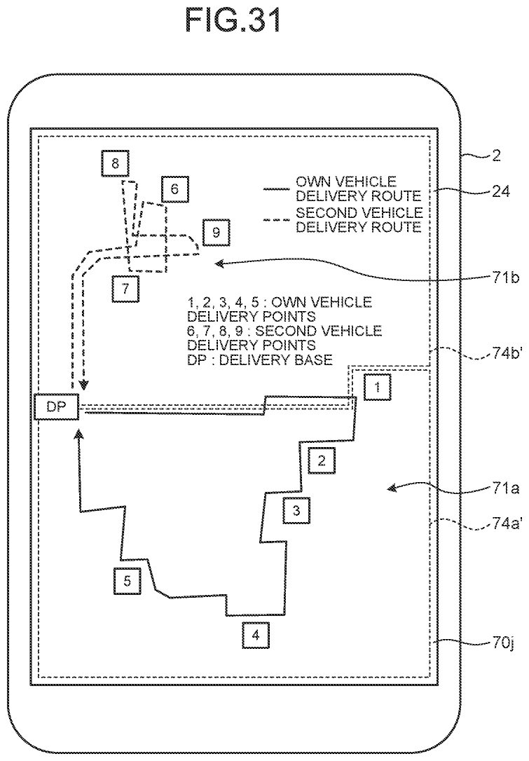

In the delivery route display processing illustrated in FIG. 7, when the delivery addresses of cargos to be received are present on the own vehicle delivery route at a rate equal to or more than the predetermined rate, the reception unit 201 further acquires area information indicating the own vehicle delivery area updated to include the delivery addresses and the adjacent second vehicle delivery area updated not to include the delivery addresses (S201). Thereafter, the display unit 202 displays the own vehicle delivery area and the second vehicle delivery area that has been updated and acquired (S202). FIG. 31 is a diagram illustrating an example of a display screen displayed in delivery route display processing according to the ninth modification. A display screen 70j in FIG. 31 includes an updated own vehicle delivery area 74a′, and an updated second vehicle delivery area 74b′ adjacent to the own vehicle delivery area 74a′. Similarly to the display screen 70h according to the second embodiment exemplified in FIG. 25, the display screen 70j includes the own vehicle delivery route 71a as the recommended delivery route, and the reference data. The reference data includes the second vehicle delivery route 71b in the second vehicle delivery area 74b′ adjacent to the own vehicle delivery area 74a′ that is displayed to be comparable with the own vehicle delivery route 71a. The display screen 70j further includes the delivery base DP and a plurality of delivery points.

Similarly, the delivery area update unit 312 may determine whether the delivery addresses of cargos to be transferred are present on the second vehicle delivery route at a rate equal to or more than the predetermined rate (S504a). In this case, if the delivery addresses of cargos to be transferred are present on the second vehicle delivery route at a rate equal to or more than the predetermined rate (Yes at S504a), the delivery area update unit 312 updates the delivery area so that the delivery addresses are not included in the own vehicle delivery area (S504b). On the other hand, if the delivery addresses of cargos to be transferred are not present on the second vehicle delivery route at a rate equal to or more than the predetermined rate (No at S504a), the data transmission/reception unit 302 outputs the route information indicating the extracted deterioration suppressing route (S506). In the delivery route display processing illustrated in FIG. 7, when the delivery addresses of cargos to be delivered are present on the second vehicle delivery route at a rate equal to or more than the predetermined rate, the reception unit 201 further acquires area information indicating the own vehicle delivery area that is updated not to include the delivery addresses and the adjacent second vehicle delivery area that is updated to include the delivery addresses (S201). Thereafter, the display unit 202 displays the own vehicle delivery area and the second vehicle delivery area that has been updated and acquired (S202).

In this way, when the delivery addresses of cargos to be received/transferred are assumed to be reception/transfer targets at a rate equal to or more than the predetermined rate, the delivery route display system 1 according to the ninth modification displays the updated delivery areas together with the acquired own vehicle delivery route and at least one second vehicle delivery route in a comparable manner. With this configuration, the delivery driver can compare the delivery areas that are updated based on the track record of reception/transfer of cargos between the own vehicle delivery area and the second vehicle delivery area, the own vehicle delivery route, and the second vehicle delivery route with each other. Due to this, the user can eliminate a sense of unfairness with respect to the adjacent second vehicle delivery area more easily. That is, the delivery route display system 1 according to the ninth modification can improve the effect of prompting the user to use the recommended own vehicle delivery route.

The techniques according to the embodiments and the modifications described above can be appropriately combined with each other. For example, in the first embodiment, the fact that the deterioration suppressing route is similarly recommended in the adjacent delivery area may be displayed as the evaluation index. For example, in the second embodiment, the point, the record value, and the like that are calculated for the adjacent delivery area may be displayed as the evaluation indexes. For example, in the second embodiment, when cargos addressed to the delivery addresses in the second vehicle delivery area adjacent to the own vehicle delivery area are not present on the own vehicle delivery route (No at S503), the reference data according to the first embodiment may be further displayed instead of the own vehicle delivery route. Specifically, when the delivery addresses in the second vehicle delivery area are not present on the own vehicle delivery route, or when the delivery addresses in the own vehicle delivery area are not present on the second vehicle delivery route, the delivery route display system 1 according to the second embodiment may display, together with the own vehicle delivery route, the assumed route that is estimated based on the delivery information 4 and the delivery result data 5, and the evaluation index with which the own vehicle delivery route and the assumed route can be quantitatively evaluated. As the evaluation index, the evaluation indexes according to the embodiments and the modifications described above can be appropriately used.

Each of the computer programs executed by the delivery route display system 1 according to the embodiments and the modifications is recorded and provided in a computer-readable recording medium such as a CD-ROM, a flexible disk (FD), a CD-R, and a digital versatile disc (DVD), as an installable or executable file.

Each of the computer programs executed by the delivery route display system 1 according to the embodiments and the modifications may be stored in a computer connected to a network such as the Internet and provided by being downloaded via the network. Furthermore, each of the computer programs executed by the delivery route display system 1 according to the embodiments and the modifications may be provided or distributed via a network such as the Internet.

Each of the computer programs executed by the delivery route display system 1 according to the embodiments and the modifications may be embedded and provided in a ROM, for example.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display terminal comprising:
a memory; and
a hardware processor coupled to the memory,
the hardware processor being configured to:
acquire route information indicating a first traveling route and a second traveling route; and
configured to display the first traveling route and the second traveling route, wherein
the first traveling route is a route related to an own vehicle among a plurality of traveling routes for suppressing battery deterioration related to a plurality of vehicles calculated based on destination information related to a plurality of destinations and accumulated battery data, and
the second traveling route is a route related to a second vehicle in a traveling area adjacent to a traveling area of the own vehicle among the plurality of traveling routes.

2. The display terminal according to claim 1, wherein the hardware processor is configured to acquire route information indicating the first traveling route and the second traveling route when a destination in the traveling area of the second vehicle is present on the first traveling route.

3. The display terminal according to claim 1, wherein the hardware processor is configured to acquire the route information indicating the first traveling route and the second traveling route when a destination in the traveling area of the own vehicle is present on the second traveling route.

4. The display terminal according to claim 1, wherein the hardware processor is configured to:
further acquire destination information related to a destination in the traveling area of the second vehicle, the destination being present on the first traveling route, and a destination in the traveling area of the own vehicle, the destination being present on the second traveling route; and
further display the acquired destination information.

5. The display terminal according to claim 1, wherein the hardware processor is configured to:
further acquire a change rate indicating a ratio between a number of destinations in the traveling area of the second vehicle, the destinations being present on the first traveling route, and a number of destinations in the traveling area of the own vehicle, the destinations being present on the second traveling route; and
further display the acquired change rate.

6. The display terminal according to claim 1, wherein the hardware processor is configured to:
when a specific destination in the traveling area of the second vehicle among the plurality of destinations is present on the first traveling route at a rate equal to or more than a predetermined rate, further acquire area information indicating the traveling area of the own vehicle and the traveling area of the second vehicle that are updated such that the specific destination is included in the traveling area of the own vehicle; and
further display the updated traveling area of the own vehicle and traveling area of the second vehicle.

7. The display terminal according to claim 1, wherein the hardware processor is configured to:
further acquire a usage rate indicating a ratio at which a driver uses the first traveling route, based on traveling history data of the driver; and
further display the acquired usage rate.

8. The display terminal according to claim 1, wherein the hardware processor is configured to:
further acquire information on at least one of a time, a distance, and a congestion state related to each of the first traveling route and the second traveling route; and
further display the acquired information.

9. The display terminal according to claim 1, wherein the hardware processor is configured to:
acquire route information indicating the first traveling route when no destination in the traveling area of the second vehicle is present on the first traveling route, or when no destination in the traveling area of the own vehicle is present on the second traveling route; and
display the acquired first traveling route.

10. The display terminal according to claim 1, wherein the hardware processor is configured to:
acquire route information indicating the first traveling route and a traveling route assumed by a driver that is estimated based on the destination information and traveling history data of the driver, and evaluation indexes of the traveling route assumed by the driver and the first traveling route, when no destination in the traveling area of the second vehicle is present on the first traveling route, or when no destination in the traveling area of the own vehicle is present on the second traveling route; and
display the evaluation indexes together with the traveling route assumed by the driver and the first traveling route.

11. The display terminal according to claim 1, the hardware processor is further configured to calculate the first traveling route and the second traveling route based on the destination information and the battery data.

12. A display system comprising:
a server; and
the display terminal according to claim 1,
the server comprising:
a second memory; and
a second hardware processor coupled to the second memory, the second hardware processor being configured to:
calculate the first traveling route and the second traveling route based on the destination information and the battery data; and
output route information indicating the first traveling route and the second traveling route.

13. A display method comprising:
acquiring route information indicating a first traveling route and a second traveling route; and
displaying the first traveling route and the second traveling route, wherein
the first traveling route is a route related to an own vehicle among a plurality of traveling routes for suppressing battery deterioration related to a plurality of vehicles calculated based on destination information related to a plurality of destinations and accumulated battery data, and
the second traveling route is a route related to a second vehicle in a traveling area adjacent to a traveling area of the own vehicle among the plurality of traveling routes.

14. A non-transitory computer-readable medium on which an executable program is recorded, the program instructing a computer to carry out:
acquiring route information indicating a first traveling route and a second traveling route; and
displaying the first traveling route and the second traveling route, wherein
the first traveling route is a route related to an own vehicle among a plurality of traveling routes for suppressing battery deterioration related to a plurality of vehicles calculated based on destination information related to a plurality of destinations and accumulated battery data, and
the second traveling route is a route related to a second vehicle in a traveling area adjacent to a traveling area of the own vehicle among the plurality of traveling routes.
